(19) United States
(12) Patent Application Publication
(10) Pub. No.: US 2025/0231877 A1
(43) Pub. Date: Jul. 17, 2025

(54) CACHE MEMORIES IN VERTICALLY INTEGRATED MEMORY SYSTEMS AND ASSOCIATED SYSTEMS AND METHODS

(71) Applicant: Micron Technology, Inc., Boise, ID (US)

(72) Inventors: Raghukiran Sreeramaneni, Frisco, TX (US); Lingming Yang, Meridian, ID (US); Nevil N. Gajera, Meridian, ID (US)

(21) Appl. No.: 18/965,820

(22) Filed: Dec. 2, 2024

Related U.S. Application Data
(60) Provisional application No. 63/620,283, filed on Jan. 12, 2024.

(51) Int. Cl. G06F 12/0811; G06F 12/0817; G06F 13/16

(52) U.S. Cl. CPC G06F 12/0811; G06F 12/0822; G06F 13/1668

(57) ABSTRACT

System-in-packages (SiPs) having hybrid high bandwidth memory (HBM) devices, and associated systems and methods, are disclosed herein. In some embodiments, the SiP includes a base substrate, as well as a processing device and a hybrid high-bandwidth memory (HBM) device each carried by the base substrate. The processing device includes a processing unit and a first cache memory associated with a first level of a cache hierarchy. The hybrid HBM device is electrically coupled to the processing unit through a SiP bus in the base substrate. Further, the hybrid HBM device includes an interface die, one or more memory dies carried by the interface die, and a shared bus electrically coupled to the interface die and each of the memory dies. The hybrid HBM device also includes a second cache memory formed on the interface die that is associated with a second level of the cache hierarchy.

### CROSS-REFERENCE TO RELATED APPLICATION(S)

The present application claims priority to U.S. Provisional Patent Application No. 63/620,283, filed Jan. 12, 2024, the disclosure of which is incorporated herein by reference in its entirety.

### TECHNICAL FIELD

The present technology is generally related to cache memories in vertically stacked semiconductor devices and more specifically to cache memories integrated with high bandwidth memory devices.

### BACKGROUND

Microelectronic devices, such as memory devices, microprocessors, and other electronics, typically include one or more semiconductor dies mounted to a substrate and encased in a protective covering. The semiconductor dies include functional features, such as memory cells, processor circuits, imager devices, interconnecting circuitry, etc. To meet continual demands on decreasing size, wafers, individual semiconductor dies, and/or active components are typically manufactured in bulk, singulated, and then stacked on a support substrate (e.g., a printed circuit board (PCB) or other suitable substrates). The stacked dies can then be coupled to the support substrate (sometimes also referred to as a package substrate) through bond wires in shingle-stacked dies (e.g., dies stacked with an offset for each die) and/or through substrate vias (TSVs) between the dies and the support substrate.

### BRIEF DESCRIPTION OF THE DRAWINGS

FIG. 1 is a schematic diagram illustrating an environment that incorporates a high-bandwidth memory architecture.

FIG. 2 is a schematic diagram illustrating an environment that incorporates a high-bandwidth memory architecture in accordance with some embodiments of the present technology.

FIG. 3 is a partially schematic cross-sectional diagram of a system-in-package, with a combined high-bandwidth-memory device, configured in accordance with some embodiments of the present technology.

FIG. 4A is a schematic top plan view of components of a combined high-bandwidth memory device configured in accordance with some embodiments of the present technology.

FIG. 4B is a schematic routing diagram for signals through the combined high-bandwidth memory device in accordance with some embodiments of the present technology.

FIG. 5 is a flow diagram of a process for operating a hybrid high-bandwidth memory device in accordance with some embodiments of the present technology.

The drawings have not necessarily been drawn to scale. Further, it will be understood that several of the drawings have been drawn schematically and/or partially schematically. Similarly, some components and/or operations can be separated into different blocks or combined into a single block for the purpose of discussing some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, three-dimensional (3D) memory devices have been introduced. Some 3D memory devices are formed by stacking memory dies vertically, and interconnecting the dies using through-silicon (or through-substrate) vias (TSVs). Benefits of the 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 3D memory devices contribute to higher memory access speed, lower power consumption, and chip size reduction. Example 3D memory devices include Hybrid Memory Cube (HMC) and High Bandwidth Memory (HBM). For example, HBM is a type of memory that includes a vertical stack of dynamic random-access memory (DRAM) dies and an interface die (which, e.g., provides the interface between the DRAM dies of the HBM device and a host device).

In a system-in-package (SiP) configuration, HBM devices may be integrated with a host device (e.g., a graphics processing unit (GPU) and/or computer processing unit (CPU)) using a base substrate (e.g., a silicon interposer, a substrate of organic material, a substrate of inorganic material and/or any other suitable material that provides interconnection between CPU/GPU and the HBM device and/or provides mechanical support for the components of an SiP device), through which the HBM devices and host communicate. Because traffic between the HBM devices and host device resides within the SiP (e.g., using signals routed through the silicon interposer), a higher bandwidth may be achieved between the HBM devices and host device than in conventional systems. In other words, the TSVs interconnecting DRAM dies within an HBM device, and the silicon interposer integrating HBM devices and a host device, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host device (e.g., CPU/GPU) and HBM devices during operation. For example, the high-bandwidth channels can be on the order of 1000 gigabytes per second (GB/s, sometimes also referred to as gigabits (Gb)). It will be appreciated that such high-bandwidth data transfer between a CPU/GPU and the memory of HBM devices can be advantageous in various high-performance computing applications, such as video rendering, high-resolution graphics applications, artificial intelligence and/or machine learning (AI/ML) computing systems and other complex computational systems, and/or various other computing applications.

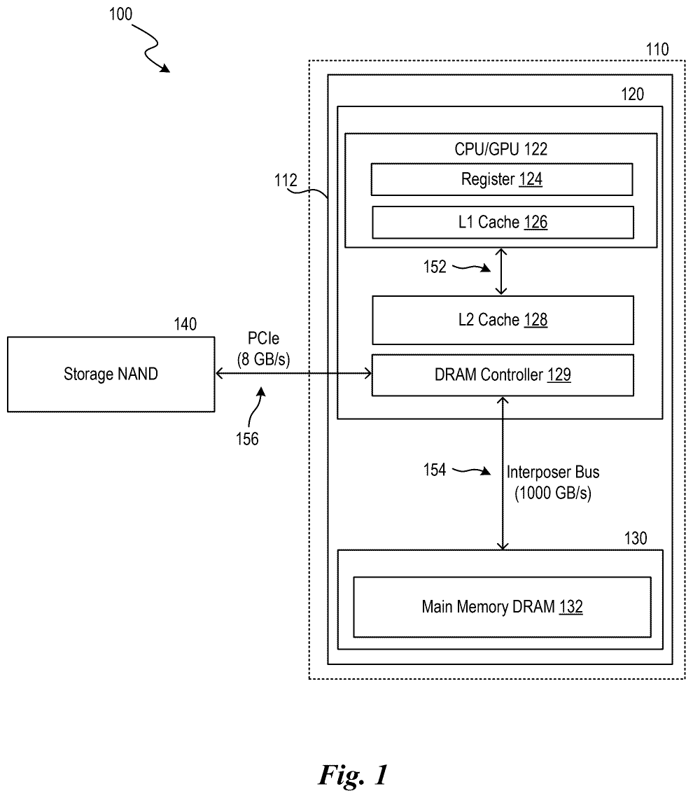

FIG. 1 is a schematic diagram illustrating an environment 100 that incorporates a high bandwidth memory architecture. As illustrated in FIG. 1, the environment 100 includes a SiP device 110 having one or more processing devices 120 (one illustrated in FIG. 1, sometimes also referred to herein as one or more “hosts”), and one or more HBM devices 130 (one illustrated in FIG. 1), integrated with a silicon interposer 112 (or any other suitable base substrate). The environment 100 additionally includes a storage device 140 coupled to the SiP device 110. The processing devices(s) 120 can include one or more CPUs and/or one or more GPUs, referred to as a CPU/GPU 122, each of which may include a register 124 and a first level of cache 126. The first level of cache 126 (also referred to herein as “L1 cache”) is communicatively coupled to a second level of cache 128 (also referred to herein as “L2 cache”) via a first communication path 152. In the illustrated embodiment, the L2 cache 128 is incorporated into the processing device(s) 120. However, it will be understood that the L2 cache 128 can be integrated into the SiP device 110 separate from the processing device(s) 120. Purely by way of example, the processing device(s) 120 can be carried by a base substrate (e.g., an interposer that is itself carried by a package substrate) adjacent to the L2 cache 128 and in communication with the L2 cache 128 via one or more signal lines (or other suitable signal route lines) therein. The L2 cache 128 may be shared by one or more of the processing devices 120 (and CPU/GPU 122 therein). During operation of the SiP device 110, the CPU/GPU 122 can use the register 124 and the L1 cache 126 to complete processing operations, and attempt to retrieve data from the larger L2 cache 128 whenever a cache miss occurs in the L1 cache 126. As a result, the multiple levels of cache can help accelerate the average time it takes for the processing device(s) 120 to access data, thereby accelerating the overall processing rates.

As further illustrated in FIG. 1, the L2 cache 128 is communicatively coupled to the HBM device(s) 130 through a second communication channel 154. As illustrated, the processing device(s) 120 (and L2 cache 128 therein) and HBM device(s) 130 are carried by and electrically coupled (e.g., integrated by) the silicon interposer 112. The second communication channel 154 is provided by the silicon interposer 112 (e.g., the silicon interposer includes and routes the interface signals forming the second communication channel, such as through one or more redistribution layers (RDLs)). As additionally illustrated in FIG. 1, the L2 cache 128 is also communicatively coupled to a storage device 140 through a third communication channel 156. As illustrated, the storage device 140 is outside of the SiP device 110, and utilizes signal routing components that are not contained within the silicon interposer 112 (e.g., between a packaged SiP device 110 and packaged storage device 140). For example, the third communication channel 156 may be a peripheral bus used to connect components on a motherboard or PCB, such as a Peripheral Component Interconnect Express (PCIe) bus. As a result, during operation of the SiP device 110, the processing device(s) 120 can read data from and/or write data to the HBM device(s) 130 and/or the storage device 140, through the L2 cache 128.

In the illustrated environment 100, the HBM devices 130 include one or more stacked volatile memory dies 132 (e.g., DRAM dies, one illustrated schematically in FIG. 1) coupled to the second communication channel 154. As explained above, the HBM device(s) 130 can be located on the silicon interposer 112, on which the processing device(s) 120 are also located. As a result, the second communication channel 154 can be provide a high bandwidth (e.g., on the order of 1000 GB/s) channel through the silicon interposer 112. Further, as explained above, each HBM device(s) 130 can provide a high bandwidth channel (not shown) between the volatile memory dies 132 therein. As a result, data can be communicated between the processing device(s) 120 and the HBM device(s) 130 (and the volatile memory dies 132 therein) at high speeds, which can be advantageous for data-intensive processing operations. Although the HBM device(s) 130 of the SiP device 110 provide relatively high bandwidth communication, their integration on the silicon interposer 112 suffers from certain shortcomings. For example, each HBM device(s) 130 may provide a limited amount of storage (e.g., on the order of 16 GB each), where the total storage provided by all of the HBM devices 130 may be insufficient to maintain the working data set of an operation to be performed by the SiP device 110. Additionally, or alternatively, the HBM device(s) 130 are made up of volatile memory (e.g., each requires power to maintain the stored data, and the data is lost once the HBM device is powered down and/or suffers an unexpected power loss).

In contrast to the characteristics of the HBM devices 130, the storage device 140 can provide a large amount of storage (e.g., on the order of terabytes and/or tens of terabytes). The greater capacity of the storage device 140 is typically sufficient to maintain large sets of data that can be parceled out to the HBM devices 130 during various computing operations performed by the SiP device 110. Additionally, the storage device 140 is typically non-volatile (e.g., made up of NAND-based storage, such as NAND flash, as illustrated in FIG. 1), and therefore retains stored data even after power is lost. However, as discussed above, the storage device 140 is located external to the SiP device 110 (e.g., not placed on the silicon interposer 112), and instead coupled to the SiP device 110 through a third communication channel 156 (e.g., PCIe) routed over a motherboard, system board, or other form of PCB. As a result, the third communication channel 156 can have a relatively low bandwidth (e.g., on the order of 8 GB/s), significantly lower than the bandwidth of the second communication channel 154.

Despite the quick communications enabled over the second communication channel 154, the SiP device 110 can still run into bottlenecks during processing. For example, data required at the CPU/GPU 122 occasionally cannot be provided by either the L1 cache 126 (sometimes referred to as an “L1 miss” and/or a “cache miss at the L1 cache”) or the L2 cache 128 (sometimes referred to as an “L2 miss” and/or a “cache miss at the L2 cache”) because the data is not present in either cache (sometimes referred to collectively as “cache misses,”). In response to a cache miss at the L1 cache 126 and a cache miss at the L2 cache 128, the DRAM controller 129 generates a request to read the data from the volatile memory dies 132 in the HBM device 130 via the second communication channel 154. The read request requires the DRAM controller 129 to request the data from particular addresses in the volatile memory dies 132 and must wait for the HBM device 130 to respond to the request before the data can be written into the L1 and/or L2 caches 126, 128. As a result, the read request can take more time and/or require more power to implement than retrieving missing data from a cache memory.

Hybrid HBM devices, and associated systems and methods, that address the shortcomings discussed above are disclosed herein. The hybrid HBM device (sometimes also referred to herein as a “combined HBM device”) can include an interface die, one or more memory dies (e.g., DRAM dies) carried by the interface die, and a shared bus electrically coupled to the interface die and each of the memory dies. The hybrid HBM device also includes a cache memory formed on the interface die that is associated with a higher level of a cache hierarchy than the cache memories formed in the processing device (e.g., an L3 cache memory). In other words, the hybrid HBM device can include another level of cache memory that can be checked before a cache miss requires missing data to be retrieved from the memory dies. In some embodiments, the interface die additionally includes a DRAM controller that can generate requests to the memory dies (e.g., in response to a miss in the L3 cache memory). In said embodiments, the processing devices coupled to the hybrid HBM devices may lack a DRAM controller included therein. Because the cache memory is able to more quickly and efficiently respond to a request for data than a full read from the memory dies, the additional cache memory can help improve the speed and power required for processing operations relying on the hybrid HBM device for data.

As explained herein, embodiments of the hybrid HBM device may be integrated into an SiP device that combines one or more of the hybrid HBM devices and one or more host devices (e.g., processing devices comprising CPUs and/or GPUs). The hybrid HBM devices and host devices of the SiP device may be placed on and/or integrated with a silicon interposer, which may provide a high bandwidth communication channel between the hybrid HBM devices and host devices.

Additional details on the hybrid HBM devices, and associated systems and methods, are set out below. For case of reference, semiconductor packages (and their components) are sometimes described herein with reference to front and back, top and bottom, upper and lower, upwards and downwards, and/or horizontal plane, x-y plane, vertical, or z-direction relative to the spatial orientation of the embodiments shown in the figures. It is to be understood, however, that the semiconductor assemblies (and their components) can be moved to, and used in, different spatial orientations without changing the structure and/or function of the disclosed embodiments of the present technology. Additionally, signals within the semiconductor packages (and their components) are sometimes described herein with reference to downstream and upstream, forward and backward, and/or read and write relative to the embodiments shown in the figures. It is to be understood, however, that the flow of signals can be described in various other terminology without changing the structure and/or function of the disclosed embodiments of the present technology.

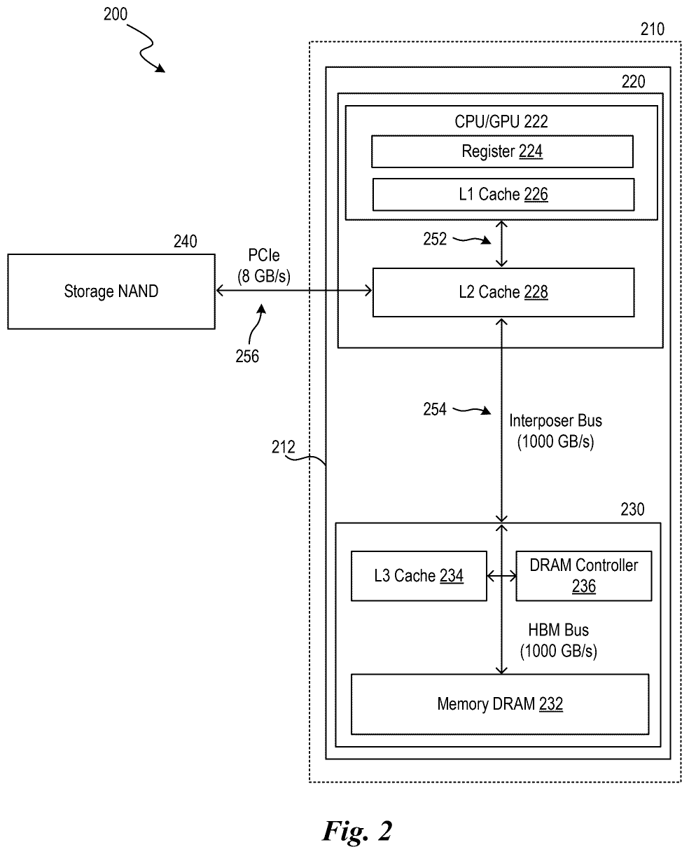

FIG. 2 is a schematic diagram illustrating an environment 200 that incorporates an HBM architecture in accordance with some embodiments of the present technology. Similar to the environment 100 discussed above, the environment 200 includes a SiP device 210 having one or more processing devices 220 (one illustrated in FIG. 2) and one or more storage devices 240 (one illustrated in FIG. 2). However, in contrast to the SiP device 110 described in FIG. 1, embodiments of the SiP device 210 illustrated in FIG. 2 includes one or more combined HBM devices 230 (one illustrated in FIG. 2), described further below. The processing device(s) 220 and the combined HBM device(s) 230 are each integrated on an interposer 212 (e.g., a silicon interposer, another organic interposer, an inorganic interposer, and/or any other suitable base substrate) that can include one or more signal routing lines. The processing device(s) 220 is driven by a CPU/GPU 222 that includes a register 224 and a L1 cache 226. The L1 cache 226 is communicatively coupled to an L2 cache 128 via a first communication channel 252. Further, the L2 cache 228 is communicatively coupled to the combined HBM devices 230 through a second communication channel 254 and to the storage device 240 through a third communication channel 256. Still further, the second communication channel 254 can have a relatively high bandwidth (e.g., on the order of 1000 GB/s) while the third communication channel 256 can have a relatively low bandwidth (e.g., on the order of 8 GB/s).

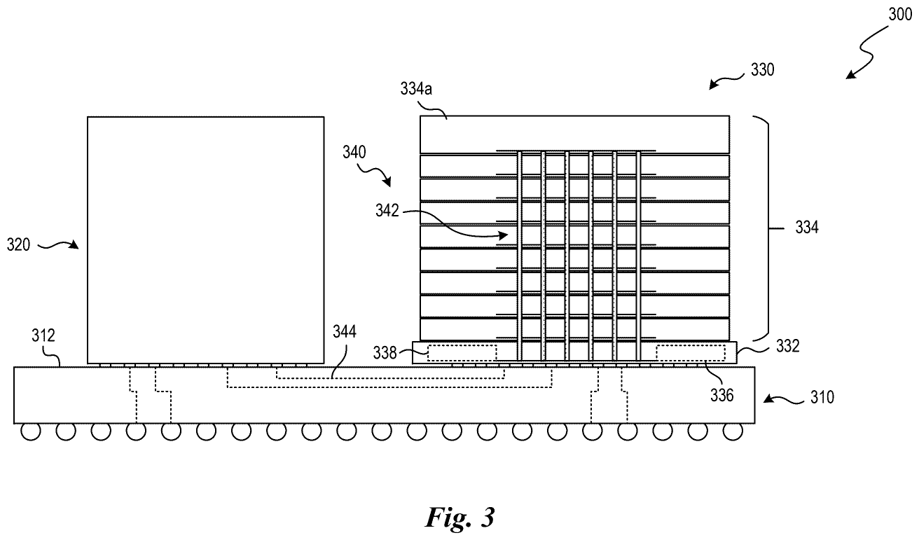

In the embodiment illustrated in FIG. 2, the combined HBM device(s) 230 (sometimes also referred to herein as “hybrid HBM devices”) each include a stack of one or more memory dies 232 (e.g., DRAM dies) and one or more L3 caches 234 (one illustrated in FIG. 2). The memory dies 232 can operate similarly, and provide functionality similar to, the volatile memory dies 132 of the HBM devices 130 illustrated in FIG. 1. The L3 cache 234 (sometimes also referred to herein as an “additional cache,” a “higher level cache,” and/or the like) can take advantage of available empty space within the combined HBM device(s) 230 to expand the cache memory available for the SiP device 210. For example, the L3 cache 234 can be part of an interface die (e.g., as discussed in more detail below with reference to FIG. 3) of the combined HBM device(s) 230. More specifically, the L3 cache 234 can include an SRAM device formed in available space on the interface die of the combined HBM device(s) 230. The additional level of cache memory can reduce the number of times the processing device(s) 220 must access the memory dies 232 in the HBM device(s) 230 in response to missing data. As a result, the L3 cache 234 can help increase a processing speed of the SiP device 210. Additionally, by reducing the number of read and write operations that must run through the memory dies 232, the L3 cache 234 can help reduce the operating power required by the SiP device 210.

As further illustrated in FIG. 2, the combined HBM device(s) 230 can also include a DRAM controller 236 operably coupled to the memory dies 232 and the L3 cache 234. In the illustrated embodiment, the DRAM controller 236 in the combined HBM device(s) 230 is a replacement of the DRAM controller 129 on the processing device 120 of FIG. 1. That is, in the embodiment illustrated in FIG. 2, the processing device(s) 220 do not include a DRAM controller. The shift accompanies the inclusion of the L3 cache 234 into the combined HBM device(s) 230 to reduce the number of back and forth signals over the second communication channel 254. More specifically, a cache miss in the L2 cache 228 can send a request to the L3 cache 234 for missing data. When the L3 cache 234 has the data, the L3 cache can send the data back to the processing device 220 without accessing the memory dies 232.

When the L3 cache 234 does not have the data, the L3 cache 234 can instruct (or request) the DRAM controller 236 to retrieve the data from the memory dies 232. Because the DRAM controller 236 is positioned at the combined HBM devices 230 (e.g., on an interface die), that instruction (or request) for data from the memory dies 232 does not have to be communicated back to the processing devices 220 via the second communication channel 254. Nor does the data read from the memory dies 232 need to make multiple trips across the second communication channel 254 to follow the instructions (or request) from the L3 cache 234 (e.g., once to move from the memory dies 232 to the DRAM controller 236, once to move to the L3 cache 234 from the DRAM controller 236, and once to move from the L3 cache 234 to the processing device 220). Instead, the data read from the memory dies 232 in response to the request is written to the L3 cache 234, and then sent to the processing device 220.

As further illustrated in FIG. 2, each of the memory dies 232, the L3 cache 234, and the DRAM controller 236 can be coupled to a high bandwidth bus in the combined HBM device(s) 230. For example, as discussed in more detail below, each combined HBM device 230 can include multiple TSVs that interconnect the memory dies 232, the L3 cache 234, and the DRAM controller 236 within the combined HBM device 230, thereby providing a high bandwidth bus. As a result, instructions, requests, and read/write signals can be communicated at high bandwidth (e.g., on the order of 1000 GB/s) within the combined HBM device 230. Thus, the L3 cache 234 can expand the cache memory for the SiP device 210 without slowing down a correction during a cache miss.

The environment 200 can be configured to perform any of a wide variety of suitable computing, processing, storage, sensing, imaging, and/or other functions. For example, representative examples of systems that include the environment 200 (and/or components thereof, such as the SiP device 210) include, without limitation, computers and/or other data processors, such as desktop computers, laptop computers, Internet appliances, hand-held devices (e.g., palm-top computers, wearable computers, cellular or mobile phones, automotive electronics, personal digital assistants, music players, etc.), tablets, multi-processor systems, processor-based or programmable consumer electronics, network computers, and minicomputers. Additional representative examples of systems that include the environment 200 (and/or components thereof) include lights, cameras, vehicles, etc. With regard to these and other examples, the environment 200 can be housed in a single unit or distributed over multiple interconnected units, e.g., through a communication network, in various locations on a motherboard, and the like. Further, the components of the environment 200 (and/or any components thereof) can be coupled to various other local and/or remote memory storage devices, processing devices, computer-readable storage media, and the like. Additional details on the architecture of the environment 200, the SiP device 210, the combined HBM device(s) 230, and processes for operation thereof, are set out below with reference to FIGS. 3-5.

FIG. 3 is a partially schematic cross-sectional diagram of a SiP device 300, with a combined HBM device 330, configured in accordance with some embodiments of the present technology. As illustrated in FIG. 3, the SiP device 300 includes a base substrate 310 (e.g., a silicon interposer, another suitable organic substrate, an inorganic substrate, and/or any other suitable material), as well as a CPU/GPU 320 and the combined HBM device 330 each integrated with an upper surface 312 of the base substrate 310. In the illustrated embodiments, the CPU/GPU 320, and associated components (e.g., the register, L1 cache, and the like) is illustrated as a single package, and the combined HBM device 330 includes a stack of semiconductor dies. The stack of semiconductor dies in the combined HBM device 330 includes an interface die 332 and one or more memory dies 334 (nine illustrated in FIG. 3). In the illustrated embodiment, the interface die 332 includes one or more additional cache memories 336 (e.g., the L3 cache 234 of FIG. 2) and a DRAM controller 338 (e.g., the DRAM controller 236 of FIG. 2) formed therein. Each of the one or more additional cache memories 336 can include an SRAM device formed in available space on the interface die 332 to expand the cache memory in the SiP device 300.

The CPU/GPU 320 is coupled to the combined HBM device 330 through a high bandwidth bus 340 that includes one or more route lines 344 (two illustrated schematically in FIG. 3) formed into (or on) the base substrate 310. In various embodiments, the route lines 344 (sometimes also referred to herein as a “SiP bus”) can include one or more metallization layers formed in one or more RDL layers of the base substrate 310 and/or one or more vias interconnecting the metallization layers and/or traces. Further, although not illustrated in FIG. 3, it will be understood that the CPU/GPU 320 and the combined HBM device 330 can each be coupled to the route lines 344 via solder structures (e.g., solder balls), metal-metal bonds, and/or any other suitable conductive bonds.

As further illustrated in FIG. 3, the high bandwidth bus 340 can also include an HBM bus 342 having a plurality of through substrate vias (“TSVs”) extending from the interface die 332, through the memory dies 334, to an uppermost memory die 334a. The HBM bus 342 allows each of the dies to communicate data within the combined HBM device 330 (e.g., between the memory dies 334 (e.g., DRAM dies) and components of the interface die 332 (e.g., the additional cache memories 336)) at a relatively high rate (e.g., on the order of 1000 GB/s or greater). In turn, the TSVs in the HBM bus 342 and the route lines 344 allow the dies in the combined HBM device 330 and the CPU/GPU 320 to communicate data at the high bandwidth.

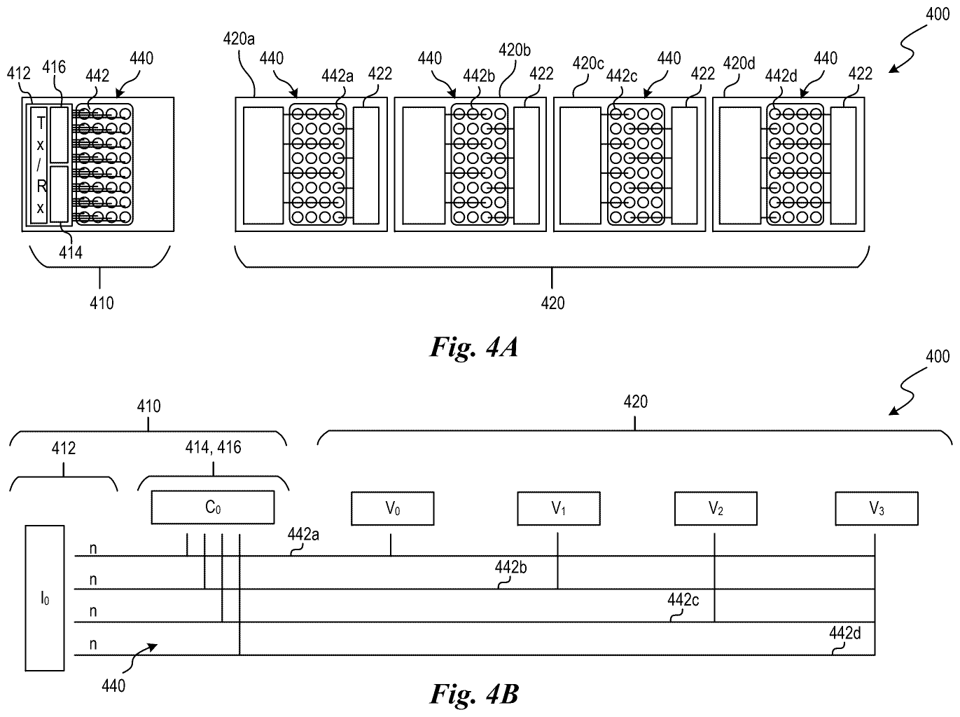

FIG. 4A is a schematic top plan view of components of a combined HBM device 400 configured in accordance with some embodiments of the present technology. As illustrated in FIG. 4A, the combined HBM device 400 is generally similar to the combined HBM device 330 described above with reference to FIG. 3. For example, the combined HBM device 400 includes an interface die 410 and one or more memory dies 420 (four illustrated in FIG. 4A), as well as a shared HBM bus 440 communicatively coupling the interface die 410 (and components thereon) and the memory dies 420.

The interface die 410 includes one or more read/write components 412 (two illustrated in FIG. 4A), a cache memory 414, and a DRAM controller 416. In various embodiments, the read/write components 412 can couple the interface die 410 to an external component (e.g., to the base substrate 310 of FIG. 3), help present information on the combined HBM device 400 to an external component (e.g., the CPU/GPU 320 of FIG. 3), and/or include memory controlling functionality to control movement of data between the memory dies 420 and the interface die 410. The cache memory 414 (e.g., an SRAM device) is formed in available space on the interface die 410 to provide an additional level of cache memory to an external device (e.g., acting as another cache memory for the CPU/GPU 320 of FIG. 3, one level higher in a hierarchy of the cache memories). The DRAM controller 416 is coupled to the cache memory 414 to help respond to cache misses. For example, the DRAM controller 416 can include memory-controlling functionality to control movement of data between the memory dies 420 and the cache memory 414 in response to a cache miss. The memory dies 420 each include memory circuits 422 (e.g., lines of capacitors and/or transistors) that can store data in volatile arrays.

As further illustrated in FIG. 4A, the shared HBM bus 440 can include a plurality of TSVs 442 (thirty-two illustrated in FIG. 4A) that extend between the interface die 410 and each of the memory dies 420. Further, the TSVs 442 can be organized into subgroups (e.g., rows, columns, and/or any other suitable subgrouping) that are selectively coupled to the dies in the combined HBM device 400 to simplify signal routing. For example, in the embodiment illustrated in FIG. 4A, a first memory die 420a can be selectively coupled to a first subgrouping 442a of the TSVs 442 (e.g., the right-most column of the TSVs 442). Accordingly, read/write operations on the first memory die 420a must be performed through the first subgrouping 442a of the TSVs 442. Similarly, as further illustrated in FIG. 4A, a second memory die 420b can be selectively coupled to a second subgrouping 442b of the TSVs 442, a third memory die 420c can be selectively coupled to a third subgrouping 442c of the TSVs 442, and a fourth memory die 420d can be selectively coupled to a fourth subgrouping 442d of the TSVs 442. In the illustrated embodiment, each of the first-fourth subgroupings 442a-442d is completely separate from the other subgroupings. As a result, each of the memory dies 420 is fully separately addressed, despite being coupled to the shared HBM bus 440. However, it will be understood that, in some embodiments, the first-fourth subgroupings 442a-442d can share one or more of the TSVs 442 and/or that each of the first-fourth memory dies 420a-420d can be coupled to a shared subgrouping of the TSVs 442 to allow one or more read/write operations to send data to multiple of the first-fourth memory dies 420a-420d at once (e.g., allowing the second memory die 420b to store a copy of the data for the first memory die 420a).

In the embodiment illustrated in FIG. 4A, the interface die 410, and each of the components thereon (e.g., the read/write components 412, the cache memory 414, and the DRAM controller 416), is coupled to each of the TSVs 442. As a result, the interface die 410 can clock and help route read/write signals to any suitable destination. For example, the DRAM controller 416 can respond to a miss in the cache memory 414 by reading data from any of the first-fourth memory dies 420a-420d and writing the data into the cache memory 414. In another example, the cache memory 414 can save a copy of any data communicated out from combined HBM device 400 by the read/write components 412 as the data is communicated.

FIG. 4B is a schematic routing diagram for signals through the combined HBM device 400 of FIG. 4A in accordance with some embodiments of the present technology. In FIG. 4B, the TSVs 442 are represented schematically by horizontal lines while the connections to the TSVs 442 (e.g., by the volatile memory dies 420 and the non-volatile memory die 430) are illustrated by vertical lines that intersect with the horizontal lines. It will be understood that each intersection can represent a connection to one or more of the TSVs 442 (e.g., eight of the TSVs 442 illustrated in each of the first-fourth subgroupings 442a-442d of FIG. 4A, a single TSV, two TSVs, and/or any other suitable number of connections).

In the embodiment illustrated in FIG. 4B, the memory dies 420 are selectively coupled to the first-fourth subgroupings 442a-442d of the TSVs 442 while interface die 410, and each of it's components, are coupled to each of the TSVs 442. For example, a first volatile link V₀ (corresponding to the first memory die 420a of FIG. 4A) is coupled to the first subgrouping 442a, a second volatile link V₁ (corresponding to the second memory die 420b) is coupled to the second subgrouping 442b, a third volatile link V₂ (corresponding to the third memory die 420c of FIG. 4A) is coupled to the third subgrouping 442c, and a fourth volatile link V₃ (corresponding to the fourth memory die 420d of FIG. 4A) is coupled to the fourth subgrouping 442d. Further, the cache memory 414 and the DRAM controller 416 are coupled to each of the first-fourth subgroupings 442a-442d of the TSVs 442 (e.g., at a cache link C₀).

During operation, a cache request from an external component (e.g., the CPU/GPU 320 of FIG. 3 and/or a cache memory component therein) can be received at an interface link I₀ by the read/write components 412 and communicated to the cache memory 414 through the TSVs 442. The cache memory 414 can then check for the requested data at the cache memory 414. If found (e.g., a cache hit), the cache memory 414 can communicate the data back to the read/write components 412 through any of the TSVs 442 to be routed to the external component. If not found (e.g., a cache miss), the cache memory 414 can instruct (or request) the DRAM controller 416 to retrieve the data from the memory dies 420 (FIG. 4A). In a specific, non-limiting example, the relevant data can be stored on the second memory die 420b of FIG. 4A. In this example, a read request signal from the DRAM controller 416 (e.g., a read) can be forwarded (via the cache link C₀) into the second subgrouping 442b. Consequently, the signal can only be received and responded to by the second volatile link V₁ (and therefore the second memory die 420b of FIG. 4A). The data is then communicated back to the DRAM controller 416 through the second subgrouping 442b and written into the cache memory 414. The cache memory 414 can then use any of the TSVs 442 to send the data, through the read/write components 412, to the external component.

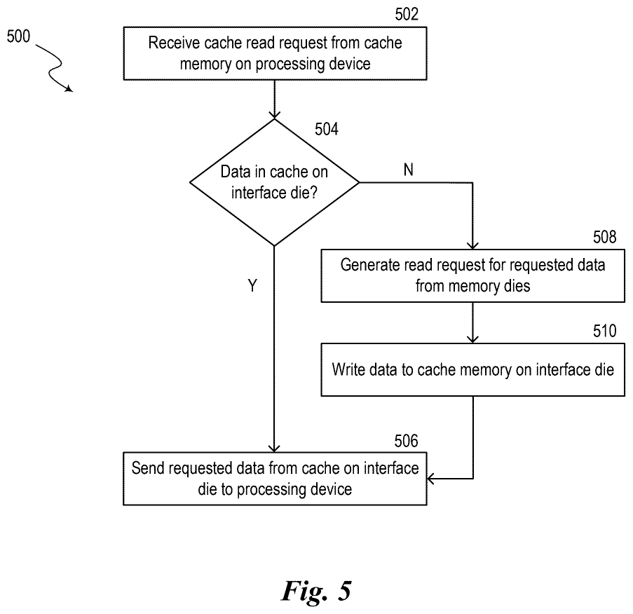

FIG. 5 is a flow diagram of a process 500 for operating a combined HBM device in accordance with some embodiments of the present technology. The process 500 can be completed by components of the interface die of the combined HBM device in response to prompts from another component (e.g., from a cache memory of the CPU/GPU 320 of FIG. 3, from the L2 cache 228 of FIG. 2, and/or the like). For example, in some embodiments, the process 500 can be implemented entirely by a cache on the interface die (e.g., the L3 cache 234 of FIG. 2, the additional cache memory 336 of FIG. 3; and/or the like). In some embodiments, the process 500 is at least partially split between multiple components of the combined HBM device. In a specific example, the process 500 can be implemented by the cache on the interface die in conjunction with read/write components on the interface die and/or a DRAM controller on the interface die.

The process 500 begins at block 502 by receiving a cache read request from the external component (e.g., cache memory on a processing device) for a set of requested data. The cache read request (the “request”) can be received in response to a cache miss in the cache memory (or cache memories) at the processing device (e.g., when there is a miss in L1 and L2 caches 226, 228 discussed above with reference to FIG. 2). The request can be received at the interface die and through a shared bus in a SiP device.

At decision block 504, the process 500 determines whether the requested data is stored in the cache memory at the interface die (e.g., the L3 cache 234 of FIG. 2). The process 500 at decision block 504 can be implemented by logic in the cache memory at the interface die (e.g., a lookup function that determines whether an address associated with the request is already resident in the cache memory of the interface die). When the requested data is found in the cache memory (e.g.., a cache hit), the process 500 proceeds to block 506 to send the requested data from the cache memory to the processing device. As a result, the cache memory allows the combined HBM device to quickly respond to the request, without needing to access the memory dies. That is, the cache memory of the interface die operates as an additional level of cache within a cache hierarchy. The direct response can help save time and/or power associated with reading the requested data from the memory dies, thereby helping improve an overall processing speed and/or operational power of the SiP device.

When at decision block 504 it is determined that the requested data is not found in the cache memory of the interface die (e.g., in a cache miss), the process 500 proceeds to block 508. At block 508, the process 500 includes generating a read request for the requested data. For example, in response to the detected cache miss in the cache memory of the interface die, a DRAM controller on the interface die (e.g., the DRAM controller 236 of FIG. 2) can generate a request to read the requested data from the memory dies in the combined HBM device. Accordingly, the read request can cause the DRAM controller to access the memory dies, through one or more TSVs in the shared HBM bus, to read the requested data.

At block 510, the process 500 includes writing the requested data, read from the memory dies, to the cache memory on the interface die (sometimes referred to as returning the requested data to the cache memory). As discussed above, the cache memory can be formed in available space on the interface die (e.g., in a peripheral region on the interface die) to provide another level of hierarchy of cache memory (e.g., a third level of cache memory). Accordingly, the write at block 510 allocates space for the requested data in the cache memory on the interface die. As a result, the data can be retrieved from the cache memory on the interface die in response to future requests for the data, rather than retrieved from the memory dies again. The direct response from the cache memory on the interface die can help accelerate the combined HBM device's response to future requests, thereby improving overall processing speed in a SiP device. In some embodiments, the writing at block 510 requires the requested data to overwrite data in the cache memory at the interface die, evict data from the cache memory at the interface die, etc.

Once the requested data has been written to the cache on the interface die at block 510, the process 500 proceeds to block 506 to send the requested data from the cache memory to the processing device (e.g., to the L2 cache 228 at the processing device 220 of FIG. 2). In some embodiments, the requested data can then overwrite data in one or more cache memories at the processing device.

Although FIG. 5 illustrates a flow diagram of an example process 500 for operating a combined HBM device in response to a request by a processing device for data (e.g.., a read request), it will be appreciated that the combined HBM device can also operate in response to requests from the processing device to store data (e.g., a write request). For example, in response to a write request from a processing device, the combined HBM device can determine whether the address associated with the write request is already resident in the cache memory of the combined HBM device. If the address is already resident in the combined HBM device, the corresponding cache line is updated based on the write data associated with the write request. For example, the cache line or a portion thereof can be overwritten with the write data received from the processing device. If the address is not already resident in the combined HBM device, a cache line may be allocated, to which the write data from the processing device is written. Allocating a cache line in the cache memory, in response to the write request, may additionally (or alternatively) involve evicting the data contents of a valid cache line to the memory dies of the combined HBM device.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “generally”, “approximately,” and “about” are used herein to mean within at least within 10 percent of a given value or limit. Purely by way of example, an approximate ratio means within ten percent of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Thus, computer-readable media can comprise computer-readable storage media (e.g., “non-transitory” media) and computer-readable transmission media.

It will also be appreciated that various modifications may be made without deviating from the disclosure or the technology. For example, although the foregoing describes embodiments in which a processing device includes a first two levels of a cache within a cache hierarchy (e.g., a L1 cache and a L2 cache) and the combined HBM device includes a third level of a cache within the cache hierarchy (e.g., a L3 cache), it will be appreciated that, in some embodiments, the processing device can have greater or fewer cache levels. For example, a processing device may have only a L1 cache and the combined HBM device may therefore include a L2 cache. In another example, a processing device may have a L1 cache, a L2 cache, and a L3 cache, and the combined HBM device may include a L4 cache. Additionally, or alternatively, the combined HBM device may include multiple levels of cache within the cache hierarchy (e.g., a smaller L3 cache that can respond more quickly to requests from the processing device and a larger L4 cache that requires more time to respond to processing device requests). As a further example, the dies in the combined HBM device can be arranged in any other suitable order (e.g., with the non-volatile memory die(s) positioned between the interface die and the volatile memory dies; with the volatile memory dies on the bottom of the die stack; and the like). Further, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. For example, although discussed herein as using a non-volatile memory die (e.g., a NAND die and/or NOR die) to expand the memory of the combined HBM device, it will be understood that alternative memory extension dies can be used (e.g., larger-capacity DRAM dies and/or any other suitable memory component). While such embodiments may forgo certain benefits (e.g., non-volatile storage), such embodiments may nevertheless provide additional benefits (e.g., reduce the traffic through the bottleneck, allowing many complex computation operations to be executed relatively quickly, etc.).

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A system-in-package (SiP) device, comprising:
a base substrate;
a processing device carried by the base substrate, wherein the processing device comprises a processing unit and a first cache memory associated with a first level of a cache hierarchy; and
a hybrid high-bandwidth memory (HBM) device carried by the base substrate and electrically coupled to the processing unit through a SiP bus, the hybrid HBM device comprising:
an interface die;
one or more memory dies carried by the interface die;
a shared bus electrically coupled to the interface die and each of the one or more memory dies; and
a second cache memory formed on the interface die, wherein the second cache memory is associated with a second level of the cache hierarchy.

2. The SiP device of claim 1 wherein the second level of the cache hierarchy is higher than the first level of the cache hierarchy.

3. The SiP device of claim 1 wherein the second cache memory formed on the interface die is communicably coupled to the shared bus to save a copy of data sent to the processing device from the one or more memory dies.

4. The SiP device of claim 1 wherein the shared bus includes one or more through substrate vias (TSVs) extending from the interface die to an uppermost memory die, and wherein the second cache memory is communicably coupled to each of the one or more TSVs.

5. The SiP device of claim 1 wherein the hybrid HBM device further comprises a DRAM controller formed on the interface die, wherein the DRAM controller is communicably coupled to the shared bus and operatively coupled to the second cache memory.

6. The SiP device of claim 5 wherein the DRAM controller is configured to:
receive a read request from the second cache memory for requested data that is stored in the one or more memory dies;
read the requested data to the second cache memory; and
return the requested data to the second cache memory.

7. The SiP device of claim 5 wherein the second cache memory is configured to:
receive a request, from the first cache memory, for missing data during a processing operation; and
check the second cache memory for the missing data, wherein:
when the missing data is found in the second cache memory, the second cache memory is further configured to send the missing data to the first cache memory, and
when the missing data is not found in the second cache memory, the second cache memory is further configured to send a read request to the DRAM controller for the missing data.

8. A method for operating a hybrid high bandwidth memory (HBM) device, the method comprising:
receiving, from a first cache memory on a processing device operatively coupled to the hybrid HBM device, a request for data; and
checking a second cache memory at the hybrid HBM device for the requested data, wherein:
when the requested data is found in the second cache memory at the hybrid HBM device, the method further comprises sending the requested data, from the second cache memory to the first cache memory; and
when the requested data is not found in the second cache memory, the method further comprises:
reading, from a memory die stack at the hybrid HBM device, the requested data;
writing the requested data to the second cache memory; and
sending the requested data, from the second cache memory to the first cache memory.

9. The method of claim 8 wherein the second cache memory is communicatively coupled to a shared HBM bus at the hybrid HBM device, wherein reading the requested data from the memory die stack includes reading the requested data through the shared HBM bus.

10. The method of claim 8 wherein the request is a first request for a first set of data, and wherein the method further comprises:
receiving, from the first cache memory, a second request for a second set of data; and
checking the second cache memory for the requested second set of data.

11. The method of claim 10 wherein:
when the requested second set of data is found in the second cache memory, the method further comprises sending the requested second set of data from the second cache memory to the first cache memory; and
when the requested second set of data is not found in the second cache memory, the method further comprises:
reading the requested second set of data from the memory die stack;
writing the requested second set of data to the second cache memory; and
sending the requested second set of data from the second cache memory to the first cache memory.

12. The method of claim 8 wherein the second cache memory is communicatively coupled to the first cache memory through a system-in-package (SiP) bus, and wherein sending the requested data, from the second cache memory to the first cache memory comprises communicating the requested data using the SiP bus.

13. A combined high bandwidth memory (HBM) device, comprising:
an interface die having a central portion and a peripheral portion;
a stack of memory dies carried by the interface die;
a cache memory component formed in the peripheral portion of the interface die; and
a shared bus electrically coupled to the interface die, each memory die in the stack of memory dies, and the cache memory component, wherein the shared bus is positioned at least partially within a footprint of the central portion of the interface die.

14. The combined HBM device of claim 13 wherein the shared bus includes a plurality of through substrate vias (TSVs) extending from the central portion of the interface die to an uppermost memory die in the stack of memory dies, and wherein the cache memory component is communicably coupled to each TSV in the plurality of TSVs to store a copy of any data communicated through the shared bus.

15. The combined HBM device of claim 13, further comprising a DRAM controller formed in the peripheral portion of the interface die, wherein the DRAM controller is operably coupled to the shared bus and the cache memory component.

16. The combined HBM device of claim 15 wherein the cache memory component is configured to:
receive, from a processing device external to the combined HBM device, a request for a set of data; and
check for the set of data within the cache memory component, wherein:
when the cache memory component contains the set of data, the cache memory component is further configured to send the set of data, from the cache memory component, to the processing device; and
when the cache memory component does not contain the set of data, the cache memory component is further configured to send a read request to the DRAM controller to cause the DRAM controller to read the set of data from the stack of memory dies.

17. The combined HBM device of claim 16 wherein, when the cache memory component does not contain the set of data, the cache memory component is further configured to overwrite an data stored in the cache memory component with the requested set of data.

18. The combined HBM device of claim 15 wherein the DRAM controller is configured to:
receive, from the cache memory component, a read request for a set of data stored in the stack of memory dies; and
read the set of data from the stack of memory dies through the shared bus.

19. The combined HBM device of claim 18 wherein the cache memory component is communicatively coupled between the shared bus and a system-in-package (SiP) bus, and wherein the cache memory component is configured to send the set of data to a processing device external to the combined HBM device through the SiP bus.

20. The combined HBM device of claim 13 wherein the interface die further comprises one or more read and write components formed in the peripheral portion and communicatively coupled to the cache memory component.
